(19) United States
(12) Patent Application Publication
(10) Pub. No.: US 2016/0162978 A1
(43) Pub. Date: Jun. 9, 2016

(54) METHOD AND SYSTEM FOR PROVIDING CONVERSATION QUICK PHRASES

(71) Applicant: Alibaba Group Holding Limited, George Town (KY)

(72) Inventor: Yukun HUANG, Hangzhou (CN)

(21) Appl. No.: 14/963,069

(22) Filed: Dec. 8, 2015

(30) Foreign Application Priority Data
Dec. 8, 2014 (CN) 201410743848.3

(51) Int. Cl. G06Q 30/06; G06Q 30/00; G06F 17/27

(52) U.S. Cl. CPC G06Q 30/0633; G06F 17/279; G06F 17/276; G06Q 30/016

(57) ABSTRACT

A method of providing conversation quick phrases to a user of a conversation, the method includes the step of determining first identity information of the user and second identity information of another user who is a party to the conversation. The method also includes the steps of obtaining context information corresponding to the first identity information, second identity information and the conversation and determining a stage for the conversation based upon the identity information and the context information. The method further includes the step of providing the user with one or more conversation quick phrases corresponding to both the stage and the identity information, where a conservation quick phrase includes words and information relating to instant messaging conversations of e-commerce transactions, and the context information is selected from the group of order information corresponding to the identity information and item information corresponding to the conversation.

### CROSS REFERENCE TO RELATED APPLICATION

This application claims the benefits to Chinese Patent Application No. 201410743848.3, filed on Dec. 8, 2014, which is incorporated herein by reference in its entirety.

### TECHNICAL FIELD

The present invention relates generally to communication technologies, and more particularly to a method, client system and server system for providing conversation quick phrases.

### BACKGROUND

With the development of the Internet and e-commerce technologies, instant messaging (IM) gradually becomes an important tool for users to conduct on-line and e-commerce transactions. Customers communicate with other customers as well as vendors utilizing such IM tools to negotiate aspects related to transactions and to solve problems related to commercial items. By sending instant messages, customers and vendors both communicate with each other instantly, becoming aware of the details of a transaction.

When a user transacts with different parties via IM, there is a high percentage of similar or repeated usage of certain vocabularies or phrases during communication. For example, inquires about information on pricing and shipping dates are among those conversation phrases. For a single transaction, regardless of whether the same parties are involved, such content tend to appear with high possibilities during conversations corresponding to the transaction. During each step of the communication of a transaction, customers utilizing an IM tool have to manually input the same or similar text content, let alone inputting multiple times, in order to complete the communication. Especially, in the age of mobile e-commerce becoming a main stream, due to the fact that a mobile device is operated differently than a PC computer, it is inconvenient to input from a mobile device for different parties of transactions or different transactions. This inconvenience impacts user communication efficiency, and severely affects user experience of mobile e-commerce.

### SUMMARY

The present disclosure provides for a method, client system and server system for providing conversation quick phrases to a user of a conversation based upon the present information or status of the conversation. Quick phrases are actively provided to the user for sending to the other user who is a party to the conversation such that to enhance communication efficiency and user experience.

According to an exemplary embodiment of the present disclosure, a method of providing conversation quick phrases to a user of a conversation includes the step of determining the first identity information of the user and the second identity information of another user who is a party to the conversation. The method also includes the steps of obtaining context information corresponding to the first identity information, the second identity information and the conversation, and determining a stage for the conversation based upon the identity information and the context information. The method further includes the step of providing the user with one or more conversation quick phrases corresponding to both the stage and the identity information, where a conversation quick phrase comprises words and information relating to instant messaging conversations of e-commerce transactions, and the context information is selected from the group of order information corresponding to the identity information and item information corresponding to the conversation.

According to another exemplary embodiment of the present disclosure, a client system for providing conversation quick phrases includes an identity determination module, an information obtaining module, a stage determination module and an information providing module. The identity determination module is configured for determining identity information of the user and identity information of another user who is a party to the conversation. The information obtaining module is configured for obtaining context information corresponding to the identity information and the conversation. The stage determination module is configured for determining a stage for the conversation based upon the identity information and the context information. And, the information providing module is configured for providing the user with one or more conversation quick phrases corresponding to both the stage and the identity information, where a conversation quick phrase comprises words and information relating to instant messaging conversations of e-commerce transactions, and the context information is selected from the group of order information corresponding to the identity information and item information corresponding to the conversation.

According to yet another exemplary embodiment of the present disclosure, a method for providing conversation quick phrases by a server includes the step of retrieving from the server's data store presently stored conversation phrases. The method also includes the step of filtering the retrieved conversation phrases to obtain high usage frequency phrases corresponding to category information and classifying the filtered high usage frequency phrases into quick phrases corresponding to stages of a conversation, wherein the category information comprises categories of items and statuses of orders. The method further includes the step of converting and arranging, according to a pre-determined format, the quick phrases such that a client periodically obtains the quick phrases from the server and updates accordingly, where a quick phrase comprises words and information relating to instant messaging conversations of e-commerce transactions.

According to still yet another exemplary embodiment of the present disclosure, a server system for providing conversation quick phrases to a user of a conversation includes an obtaining module, a classifying module and a processing module. The obtaining module is configured for retrieving from the server's data store presently stored conversation phrases. The classifying module is configured for filtering the retrieved conversation phrases to obtain high usage frequency phrases corresponding to category information and classifying the filtered high usage frequency phrases into quick phrases corresponding to stages of a conversation, where the category information comprises categories of items and statuses of orders. The processing module is configured for converting and arranging, according to a pre-determined format, the quick phrases such that a client periodically obtains the quick phrases from the server and updates accordingly, where a quick phrase comprises words and information relating to instant messaging conversations of e-commerce transactions.

### DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a flow chart of an exemplary method of providing conversation quick phrases in accordance with an embodiment of the present disclosure;

FIG. 2 is a block diagram of a client system in accordance with an embodiment of the present disclosure;

FIG. 3 is a flow chart of another exemplary method of providing conversation quick phrases in accordance with an embodiment of the present disclosure; and

FIG. 4 is a block diagram of a server system in accordance with an embodiment of the present disclosure.

### DETAILED DESCRIPTION

In the following description, numerous specific details are set forth in order to provide a thorough understanding of the present disclosure. However, it will become obvious to those skilled in the art that the present disclosure may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments mutually exclusive of other embodiments. Used herein, the terms “upper”, “lower”, “top”, “bottom”, “middle”, “upwards”, and “downwards” are intended to provide relative positions for the purposes of description, and are not intended to designate an absolute frame of reference. Further, the order of blocks in process flowcharts or diagrams representing one or more embodiments of the disclosure do not inherently indicate any particular order nor imply any limitations in the disclosure.

In accordance with embodiments of the present disclosure, in order to enable users to quickly and conveniently initiate conversations with another user during any stage of a transaction, at the time when quick phrases are to be displayed to the user of a conversation, a method includes determining a stage for the conversation and providing to the user one or more conversation quick phrases. The quick phrases correspond to both the stage and the identity information. Thus, the user can communicate quickly and conveniently with the other user of the conversation, eliminating the inconvenience caused by the difficulty and repetition related to user input.

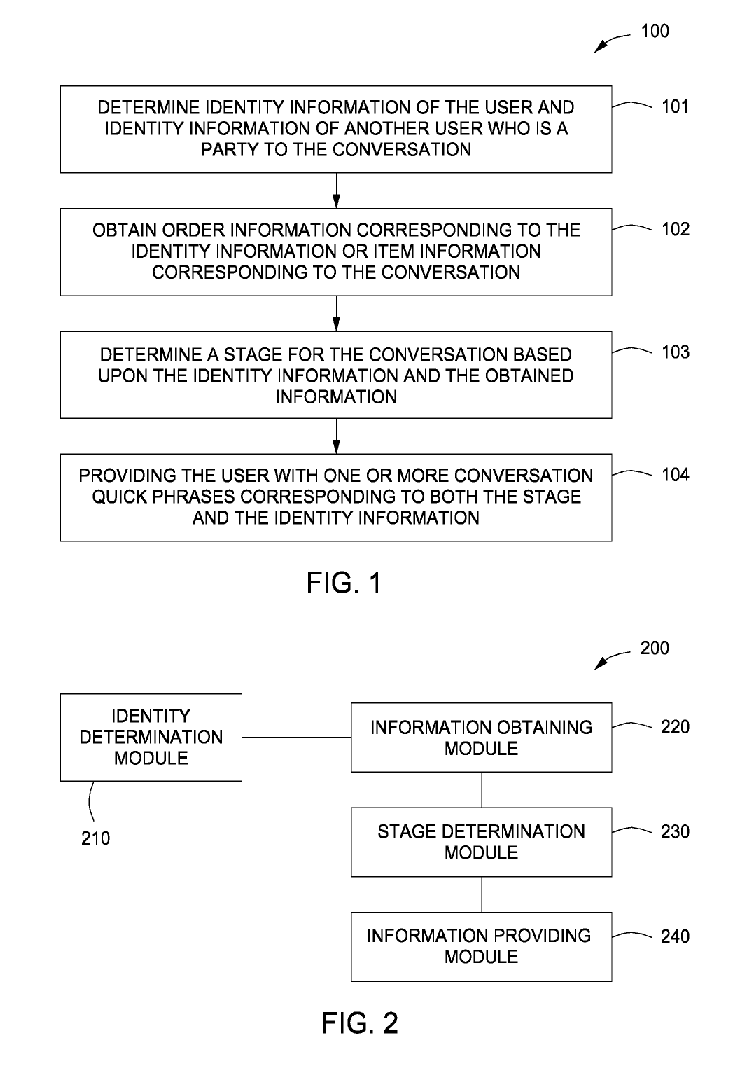

Embodiments of the present disclosure are discussed herein with reference to FIGS. 1-4. However, those skilled in the art will readily appreciate that the detailed description given herein with respect to these figures is for explanatory purposes as the disclosure extends beyond these limited embodiments.

Conversation quick phrases refer herein to words, phrases, entire sentences, partial sentences, and any information that relate to or appear in conversations or communications.

Referring to FIG. 1, a flow chart of an exemplary method of providing conversation quick phrases in accordance to an embodiment of the present disclosure is shown. The method 100 is illustrated from the perspective of client ends, detailing on how to provide to a user of a conversation with quick phrases corresponding to the stage of the conversation, as well as the sending of the quick phrases.

The method 100 starts in step 101, where the identity information of the user and another user who is a party to the conversation is determined at the time when conversational quick phrases are to be displayed to the user. In particular, there are multiple ways for the user to enter into a conversation. For example, it can be done by the user clicking on an icon of “starting chat” upon browsing onto an information web page of a commercial item (goods and/or services) or a confirmation or information web page of an order. With an information web page of an item, generally there is link information regarding the vendors of the item described in the web page. With an information or confirmation web page of an order, generally there is similar link information regarding the vendor with whom the order is placed. Therefore, when the user clicks on the icon of “start chatting,” it translates into sending a request to establish a conversation. Such a request will include content according to the content of the web pages that allows the user to click onto the icon. In details, if the user initiates a conversation via clicking on the icon for establishing a conversation from an information web page of an item, in order to facilitate the user to subsequently send to the corresponding vendor a link to the item, the request will include a web page identifier corresponding to the item. On the other hand, if the user initiates a conversation via clicking on the icon for establishing a conversation from an information or confirmation web page of an order, the request will include an order identifier corresponding to the order such that later on a present status of the order can be obtained quickly based upon the order identifier.

Accordingly, as the client system servicing the user, prior to step 101, a request to establish a conversation will be received, and the content of the request will be obtained. After step 101, if the request includes a web page identifier for an item, link information regarding the item will be generated based upon the web page identifier. The user will be prompted regarding whether or not to send the generated link information. If the request includes an order identifier for an order, the method 100 continues to determine the identity information of the user and the other user who is a party to the conversation.

Regardless of how the above described conversation is requested for establishment, at the time when conversation quick phrases are to be displayed to the user for the present conversation, the identity information of both the user and the other user who is a party to the conversation can be obtained from a server. In particular, it can be determined by use of a user ID to retrieve the identification information from a pre-configured relationship between the user ID and identification information.

For example, when the user browses onto a web page of an item and clicks on the button of “contact vendor” from the web page, the client system will recognize this event as a request by the user to establish a conversation. Subsequently, it adds to the request the web page identifier of the web page from which the user initiates the request to establish the conversation, and sends the request to a server. After receiving the request, the server will obtain and determine from the included content of the request whether there is a web page identifier corresponding to an item. In order for the user to quickly inform the vendor of the item of interest or in inquiry, the server generates link information based upon the web page identifier and prompts the user about whether or not to send the link information.

For another example, when inquiring with a vendor regarding an order, the user clicks on the button of “contact vendor” from an information or confirmation web page of an order. The client system likewise recognizes the event as a request by the user to establish a conversation. It further adds to the request the order identifier corresponding to the web page of the order, and sends the request to a server. After receiving the request containing the order identifier, the server determines the order corresponding to the order identifier, and continues to determine the identity information of the user and the other user who is the other party to the requested conversation.

In a preferred embodiment of the present disclosure, prior to receiving the request by the user to establish a conversation, it can be first determined whether the user has logged onto the client system (including web client and mobile client). If the user has indeed logged on, then the identity information corresponding to the user can be obtained from a data store, based upon the user ID under which the user has logged onto the system. Consequently, prior to determining the identity information of the user and the other user to the conversation, the request to establish a conversation can be accepted and the content included in the request can be obtained accordingly. If the request includes a web page identifier of an item, link information regarding the item will be generated based upon the web page identifier. The user will be prompted regarding whether or not to send the link information. If the request includes an order identifier of an order, the method continues to determine the identity information of the user and the other user who is a party to the conversation.

For example, when the user is browsing upon an item of clothing from a web client or a mobile client, there is a link to establish a conversation in the web page displaying the item of clothing. When the user starts a conversation with the vendor corresponding to the item of clothing, a server can automatically obtain the link based on the request to establish the conversation, and further obtain information on the item through the link. Alternatively, prior to any request for conversations, the browsing history for the user can be obtained beforehand. After establishing the conversation, the link corresponding to the item from the vendor can be included in the web page for the conversation. Further, when the user has browsed for a lot of items, those items can be selected based upon a pre-determined policy. For example, if the present season is winter, winter wear will be preferred. Alternatively, the item the user spends the longest time browsing will be preferred.

In step 102, context information corresponding to the identity information and the conversation is obtained. The context information can be order information corresponding to the obtained identity information, or item information corresponding to the conversation. In order to distinguish between the identities of the two parties to the conversation, in accordance to embodiments of the present disclosure, the user's identity is a first identity, while the other user who is the other party to the conversation is a second identity. In a preferred embodiment, during the process of obtaining the order information corresponding to the identity information or the item information corresponding to the conversation, it will be queried to determine whether there is an order corresponding to both the first identity and the second identity at the same time.

When there is an order corresponding to both the first and second identities, it indicates that an order has already been placed between the users, only that either the delivery has not been confirmed or has been confirmed with the customer intending to communicate with the vendor regarding the delivered order. Therefore, the order status of the existent order can be obtained based on an order ID of the order. The order ID and the order status can be designated as the order information, the order status indicating a status of complete or incomplete. When the user converses with the other user, it can be queried regarding whether there is an order placed between the user and the other user. In other words, it can be determined whether the user has ordered items from the other user. For example, after the user purchases a pair of shoes on the website of “taobao”, if the user has already received the shoes, the order is complete. If the order of the pair of shoes has been placed, the server generates an order identifier corresponding to the order. Prior to the user receiving the delivery to the shoes, the status for the order is incomplete.

When there is no order corresponding to both the first identity and second identity, it indicates that there is no order placed between the users. Thus, item IDs and corresponding category information can be determined based upon the content of the conversation. The item IDs and category information can be designated as the item information. Further, if there is no orders between the user and the other user, information of the items the user has browsed onto can be obtained. For example, such information can be information of items browsed by the user during a certain period of time, or information of an item of a certain category offered in multiple stores the user has browsed into. Based on such information, item IDs and category information can be obtained.

In a preferred embodiment of the present disclosure, when determining item IDs and category information based upon the content of the conversation, links to web pages from the conversation will be obtained. It will also be determined whether the links relates to commercial items, and if they are, item IDs corresponding to the items will be obtained and category information corresponding to the item IDs will also be obtained accordingly.

For example, information can appear in the conversation about items which the user intends to inquire about or to purchase. The information can be generated, upon the user clicking an icon to start a conversation upon browsing onto a web page of an item, by displaying a link to the item automatically in the conversation. The information can also be generated, after the user clicking on the icon to start a conversation, by the conversation obtaining the link to the item presently browsed by the user. If there are multiple items, the link to the item on which the user spends the longest time browsing will be selected. Alternatively, other approaches can be implemented. For example, during winter seasons, when the user has browsed items of winter wear, sandals and electronics, the links to winter wear will be recorded and included in the conversation when it starts. Further, as there are multiple categories of items, it is necessary to categorize the items for the purpose of searching. For example, for men's shoes offered in a store of a vendor, there will be an item ID corresponding to the shoes. The item ID can be serial numbers from the manufacturer, or unique serial code or label assigned by the store. It can be a series of numbers or characters, or two dimensional code or bar code, or the like. The category information corresponding to the item IDs is the information regarding the category of the items, for example, men's shoes will be associated with category information with a description of: shoe category, for men, leather materials.

In step 103, a stage for the conversation is determined based upon the obtained context information and identity information. According to different stages in shopping, a stage of a conversation can be labeled as pre-sale, mid-sale and post-sale. A pre-sale stage corresponds to a stage prior to the user placing an order with a vendor to generate a purchase transaction. During a pre-sale stage, the user and the vendor likely communicate regarding items offered and shipping terms for the items. A mid-sale stage corresponds to a stage that is after the user placing an order and prior to the vendor shipping out the order. During a mid-sale stage, the user likely inquires the vendor regarding questions related to the shipping and delivery of the order. A post-sale stage corresponds to a stage after the user receives the delivery of the order, during which the user likely communicates with the vendor regarding the items delivered. Therefore, in order to determine a stage for the conversation based on the obtained context information and identity information, in some preferred embodiments, the following approaches can be utilized.

When the obtained context information is order information, and the order status corresponding to the order is incomplete, the stage of the conversion is determined as mid-sale. Taking an order placed on the website of “taobao” for example, conversations during the period of time after the user places the order on the website of “taobao” and prior to the user receives the delivery of the order, are mid-sale. When the obtained context information is order information, and the status corresponding to the order is complete, the stage of the conversation is determined as post-sale. Again, taking an order placed on the website of “taobao” for example, conversations during the period of time after the user receives the delivery of the order are post-sale. When the obtained context information is item information, the stage of the conversation is determined as pre-sale. While there is only item information, it indicates the user, i.e., the customer, is still browsing or considering with respect to purchase of items, without placing any order. For example, when the user looks up a pair of shoes offered on the website of “taobao” without paying for the pair of shoes, it indicates that the user is still considering the purchase of the shoes, and accordingly, conversations during this period of time are pre-sale.

In step 104, quick phrases corresponding to both the stage of the conversation and the identity information are provided to the user. In a preferred embodiment of the present disclosure, when the identity information of the user indicates a customer status, and the stage of the conversation is determined as mid-sale or post-sale, presently available quick phrases corresponding to the customer status as well as to the mid-sale and post-sale stages are retrieved from the server. The quick phrases corresponding to the particular stage of the conversation are subsequently returned to the user.

When the identity information of the user indicates a vendor status, presently available quick phrases corresponding to the vendor status and all stages of a conversation are retrieved from the server. The quick phrases corresponding to the particular stage of the conversation are subsequently returned to the user. When the identity information of the user indicates a customer status, and the stage of the conversation is determined to be pre-sale, presently available quick phrases corresponding to the customer status are retrieved from the server. The quick phrases corresponding to the category information are subsequently returned to the user.

In particular, the identity information of the user will first be determined. Embodiments of the present disclosure provide for optimization of experience for both customers and vendors such as to provide for convenience to both parties. Therefore, it will determined first whether the user is a customer or a vendor. For example, such a status can be determined based upon the fact that customers and vendors utilize different client systems to log on. When the user status is determined as a customer, based upon the present stage of the conversation, pertinent information corresponding to the present stage of the conversation is provided to the user, i.e., the customer. For example, during a mid-sale stage, the customer inquires about the status of the delivery of the order, about whether the order has been shipped, or complains about the listing price is discounted immediately after the order is placed, etc. Quick phrases relating to all those can obtained from the server and provided to the user, without the user manually inputting corresponding phrases or information, or the user can perform all the inquires with the vendor with limited or simple modification to or completion on the basis of the obtained corresponding quick phrases.

For another example, when the user has proceeded to a post-sale stage, i.e., the user receives the delivery of the order, and intends to inquire about post-sale related questions such as, whether the ordered items can be returned or exchanged, the quality of the items, warranties for the items, return or exchange related timing, logistics and addresses information. Similarly, quick phrases corresponding to all those can be retrieved from the server and provided to the user such that the user can quickly and conveniently inquire with the vendor, without manually inputting all the conversation content from scratch, enhancing shopping efficiency and experience.

Accordingly, when the identity information of the user indicates a vendor status, in the face of the above described inquiries from a customer, similarly, corresponding quick phrases can be obtained from the server such that the vendor can respond to the customer quickly. Further, the retrieval of quick phrases from the server can be based upon either the entire communication between the vendor and the customer, or upon the configurations set by the user for use by the user. For example, with a vendor, for the r communication with customers, the vendor can design his or her own unique style in terms of quick phrases such as: “Dear Customer, the express delivery now has arrived at . . . ,” “Dear Customer, all the orders from our store are shipped via express delivery by . . . ,” or “Dear Customer, welcome to the store,” etc.

Further, prior to step 104, i.e., prior to providing the user with one or more quick phrases corresponding to both the identity information and the stage of the conversation, in order for the user to send self-defined information corresponding to items of interest, two exemplary approaches can be implemented as following.

When it is determined that the stage for the conversation is pre-sale, it is determined whether the item information's category information includes specification related information. If so, pre-determined format for configuring the specification is obtained and displayed to the user.

It is determined whether the category information of the items information relates to clothing or footwear. If so, a pre-determined format for size configuration is obtained and displayed to the user. Size information is obtained from the user with the pre-determined format. Quick phrases corresponding to the user is generated based upon the size information, and such quick phrases are sent to the other user of the conversation.

The above described embodiment provides for, when specification of an item varies for different users or customers (for example, items of clothing or footwear), configuring specification or size information by displaying to the user the format for configuring in advance. In particular, for household electronics, corresponding quick phrases can be set to include weight, size, volume, etc. configuration format to the user such that it is convenient for the user to select or respond. Further, in a winter season, quick phrases for items of winter wear can include information on materials such as cotton, linen, silk etc., and the degrees of insulation, all can be displayed to the user according to a pre-determined format.

After step 104, according to the user's different choices, the quick phrases can be sent to the other user who is a party to the conversation. After the quick phrases are provided and displayed to the user, quick phrases selected by the user are sent to the user who is a party to the conversation. After obtaining the configuration information input by the user with the pre-determined format, one or more configuration related quick phrases corresponding to the user are generated based upon the configuration information, and the configuration related quick phrases are sent to the other user of the conversation. After obtaining size information input by the user with the pre-determined format, one or more size related quick phrases corresponding to the user are generated based upon the size information, and the size related quick phrases are sent to the other user of the conversation.

Referring to FIG. 2, a block diagram of an exemplary client system for providing conversation quick phrases in accordance to an embodiment of the present disclosure is shown. The client system 200 includes an identity determination module 210, an information obtaining module 220, a stage determination module 230 and a information providing module 240.

The identity determination module 210 is configured for, at the time when quick phrases are to be displayed to the user for the present conversation, determining the identity information of the user and the identity information of the other user who is a party to the conversation. The information obtaining module 220 is configured for obtaining context information corresponding to the identity information and the conversation. The stage determination module 230 is configured for determining a stage for the conversation based upon the identity information and the context information. And the information providing module 240 is configured for providing the user with one or more conversation quick phrases corresponding to both the stage and the identity information, where the context information is selected from the group of order information corresponding to the identity information and item information corresponding to the conversation.

In some alternative embodiments, the stage for the conversation is selected from the group of pre-sale, mid-sale and post-sale.

In some other alternative embodiments, the identity information for the user is a first identity information, the identity information for the other user who is a party to the conversation is a second identity information. Further, the information obtaining module 220 includes an inquiry sub-module, an order information obtaining sub-module, and an item information obtaining sub-module. The inquiry sub-module is configured for querying to determine whether there is an order corresponding to the first identity information and the second identity information at the same time. The order information obtaining sub-module is configured for, if there is an corresponding order, obtaining order status information based upon an order ID of the order, where the order ID and the order status information is designated as the order information, the order status information indicating a status of complete or incomplete. The item information obtaining sub-module is configured for, if there is no corresponding order, determining an item ID and category information of an item based upon information of the conversation, where the item ID and the category information is designated as the item information.

In some further alternative embodiments, the stage determining module 230 can be configured for, if the context information is order information and the order status information of the order information is incomplete, determining the stage for the conversation as mid-sale. If the context information is order information and the order status information of the order information is complete, the stage determining module 230 is configured for determining the stage for the conversation as post-sale; and if the context information is item information, determining the stage for the conversation as pre-sale.

In still some further alternative embodiments, the information providing module 240 is configured for retrieving from a server, if the identity information of the user indicates a customer status and the stage for the conversation is mid-sale or post-sale, presently available conversation quick phrases corresponding to the customer status for mid-sale and post-sale stages, and returning to the user the conversation quick phrases corresponding to the stage for the conversation. If the identity information of the user indicates a vendor status, the information providing module 240 is configured for retrieving from a server presently available conversation quick phrases corresponding to the vendor status for pre-sale, mid-sale and post-sale stages, and returning to the user the conversation quick phrases corresponding to the stage for the conversation. If the identity information of the user indicates a customer status and the stage for the conversation is pre-sale, the information providing module 240 is configured for retrieving from a server presently available conversation quick phrases corresponding to the customer status, and returning to the user the conversation quick phrases corresponding to the category information.

In still some further alternative embodiments, the item information obtaining sub-module is configured for obtaining link information from the information of the conversation and determining whether the link information relates to an item. If so, the item information obtaining sub-module is configured for obtaining an item ID of the item relates to the link information and determining category information based upon the item ID.

In some alternative embodiments, the client system 200 can further include a self-defining information module configured for, if the stage determination module determines that the stage for the conversation is pre-sale, determining whether the category information includes specification information. In response to a determination that the category information includes specification information, the self-defining information module is configured for obtaining and displaying to the user a pre-determined format for configuring the specification information.

In some other alternative embodiments, the client system 200 can further include a self-defining information module configured for, if the stage determination module determines that the stage for the conversation is pre-sale, determining whether the category information relates to clothing or footwear. In response to a determination that the category information relates to clothing or footwear, the self-defining information module is configured for obtaining and displaying to the user a pre-determined format for size configuration.

In some further alternative embodiments, the client system 200 can further include an information sending module configured for, after providing the user with one or more conversation quick phrases corresponding to both the stage and the identity information, obtaining conversation quick phrases selected by the user and sending the conversation quick phrases selected by the user to the other user of the conversation.

In some still further alternative embodiments, the client system 200 can further include an information sending module configured for, after providing the user with one or more conversation quick phrases corresponding to both the stage and the identity information, obtaining configuration information input by the user with the pre-determined format, generating one or more configuration related quick phrases corresponding to the user based upon the configuration information, and sending the configuration related quick phrases to the other user of the conversation.

In some still yet further alternative embodiments, the client system 200 can further include an information sending module configured for, after providing the user with one or more conversation quick phrases corresponding to both the stage and the identity information, obtaining size information input by the user with the pre-determined format, generating one or more size related quick phrases corresponding to the user based upon the size information, and sending the size related quick phrases to the other user of the conversation.

In some other alternative embodiments, the client system 200 can further include a pre-processing module configured for, prior to determining identity information of the user and identity information of another user who is a party to the conversation, receiving from the user a request for establishing the conversation and obtaining content from the request. If the request contains a web page identification corresponding to an item, based upon the web page identification, the pre-processing module is configured for generating link information relates to the item and prompting the user about whether to send the link information. If the request contains an order identification corresponding to an order, the pre-processing module is configured for continuing to determine the identity information of the user and the identity information of the other user.

In order to provide for the user to quickly and conveniently start a conversation with another user at different stages of shopping with enhanced user experience, an exemplary server system can be implemented in accordance to an embodiment of the present disclosure to provide for server side data classifying and filtering, and providing quick phrase to the user at different stages such that the users at client end can obtained the quick phrases needed.

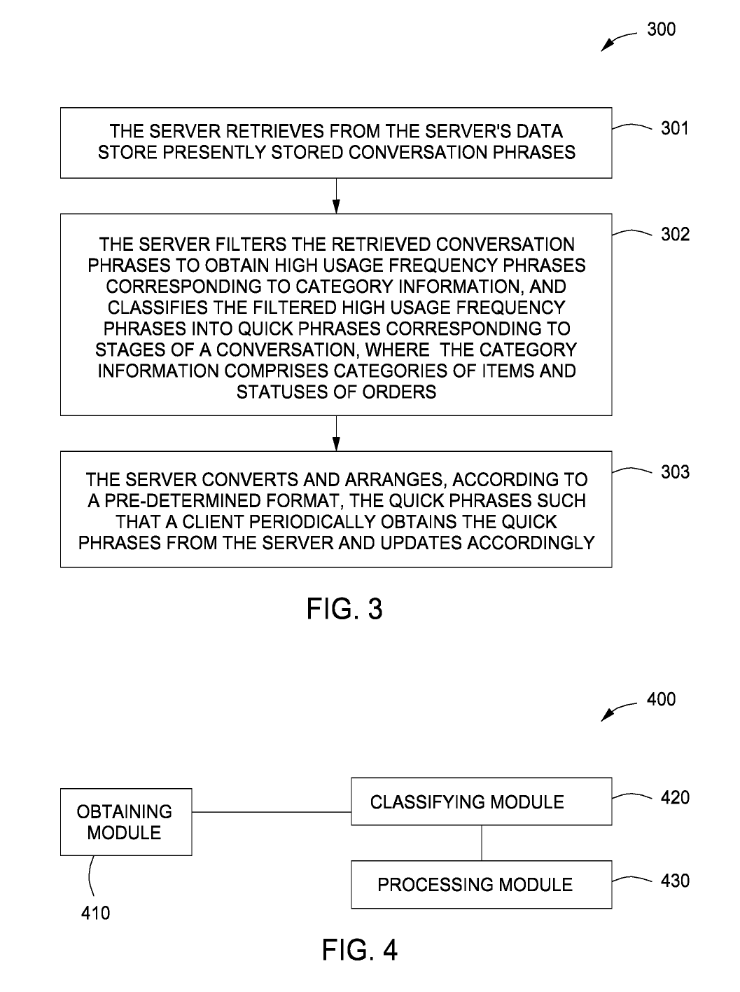

Referring now to FIG. 3, an exemplary method of providing conversation quick phrases by a server in accordance to an embodiment of the present disclosure is shown. The method 300 starts in step 301, where the server retrieves from the server's data store presently stored conversation phrases. In particular, phrases of conversations stored in the server's data store can be obtained based on high usage frequency words, phrases, sentences gathered from users. As each user has an individual account, when the user starts a conversation, the server can obtain from its data store the words, phrases and sentences often utilized by the user. Alternatively, the server can also select for high usage frequency phrases based on the entire collection of phrases in the data store.

In step 302, the server filters the obtained high usage frequency phrases to obtain high usage frequency phrases corresponding to category information, where the category information comprises categories of items and statuses of orders. The server further classifies the filtered high usage frequency phrases into quick phrases corresponding to stages of a conversation. The filtering for high usage frequency phrases corresponding to category information is an exemplary way to classify conversation phrases for different purposes.

In a preferred embodiment, stages of conversations include pre-sale, mid-sale, and post-sale stages. The category information includes categories of items, and statuses of orders. For example, categories of items can be footwear, clothing etc.; statuses of orders can be mid-sale, post sale etc. Further, with classifying the filtered high usage frequency phrases according to stages of conversation (i.e., stages of order processing), quick phrases provided for a pre-sale stage conversation, a mid-sale stage or a post-sale stage conversation differ from each other. For example, inquiries about the express delivery of an order are quick phrases for a mid-sale stage, and inquiries about returns are quick phrases for a post-sale stage.

As the subjects involved in a conversation can be an item or an order, step 320 can be implemented in two different exemplary manners. If the high usage frequency phrases filtered by the server correspond to items, the server designates such high usage frequency phrases as quick phrases corresponding to pre-sale stages. The server further classifies the designated quick phrases according to categories of items. For example, when the filtered high usage frequency phrase are inquiries about color, pricing, qualities, the corresponding category of items can be determined, and the server can designate those high usage frequency phrases as quick phrases for pre-sale stages. The server further classifies the quick phrases according to the categories of items such as footwear, clothing, electronics, food, etc. For food related quick phrases, there are inquiries on expiration dates, while for electronics related quick phrases, there are inquires on battery time, resolution of screens, ruggedness, etc.

If the high usage frequency phrases filtered by the server correspond to order statuses, the server designates the high usage frequency phrases corresponding to an incomplete status as quick phrases for mid-sale stages; and the high usage frequency phrases corresponding to an complete status as quick phrases for post-sale stages. In details, when the filtered high usage frequency phrase relate to delivery time, returning etc., the server can determine those phrases correspond to order statuses. For example, phrases relating to returns are quick phrases for post-sale stages, and phrases relating to shipping dates or delivery time are quick phrases for mid-sale stages.

In particular, the stages can be classified into pre-sale, mid-sale and post-sale according to transaction situations in which a user enters into a conversation with another user. The stage of pre-sale is the period of time prior to the user placing an order with an e-commerce vendor. The state of mid-sale is the period of time after the user placing an order and prior to receiving the delivery of the order. And the stage of post-sale is the period of time after the user receiving the delivery of the order. In a preferred embodiment, the server first retrieves from a back end data store the conversation phrases corresponding to customers and vendors, ranks the phrases based on the usage frequency, then further classify the phrases based on the above described stages and categories. If the high usage frequency phrases corresponding to the category of an item, it indicates that the user has not placed an order of the item. Therefore, the stage is still pre-sale, and those high usage frequency phrases are classified as pre-sale quick phrases. If the high usage frequency phrases correspond to an order status, it indicates that the user has placed an order on an item. Consequently, those high usage frequency phrases are classified as mid-sale or post-sale quick phrases based on the order status.

In step 303, the server converts and arranges the classified quick phrases according to a pre-determined format such that a client periodically obtains the quick phrases from the server and updates accordingly. With regard to client uploading mechanisms, after step 303, the server can receive from clients the uploading of phrases that have been sent by the users. The server accordingly updates the usage frequency of the quick phrases based on the results of uploading, and further updates and optimizes the quick phrases. This can be done by active uploading initiated at clients, or the server can actively collect conversation phrases from clients. Alternatively, a user can define conversation phrases for use of his or her only, and store the phrases in the server. The server is configured to receive such user-defined phrases from the user, and/or to monitor conversation phrases on the client end, filtering the phrases to update the server's database.

With the above described processes, by ranking, classifying and filtering conversation phrases to obtain high usage frequency quick phrases corresponding to various stages of transactions, as well as providing to the users formatted shopping related quick phrases based on information about transactions and parties to conversations, communications on the Internet become quicker and more convenient.

Referring to FIG. 4, a block diagram of an exemplary server system in accordance with embodiments of the present disclosure is shown. The server system 400 includes an obtaining module 410, a classifying module 420 and a processing module 430. The obtaining module 410 is configured for retrieving from the server's data store presently stored conversation phrases. The classifying module 420 is configured for filtering the retrieved conversation phrases to obtain high usage frequency phrases corresponding to category information and classifying the filtered high usage frequency phrases into quick phrases corresponding to stages of a conversation, where the category information comprises categories of items and statuses of orders. And the processing module 430 is configured for converting and arranging, according to a pre-determined format, the quick phrases such that a client periodically obtains the quick phrases from the server and updates accordingly.

In some alternative embodiments, the stage of a conversation is selected from the group of pre-sale, mid-sale and post-sale.

In some other alternative embodiments, the classifying module 420 is configured for designating the high usage frequency phrases corresponding to categories of items as pre-sale quick phrases, and categorizing the quick phrases according to the categories. If the high usage frequency phrases correspond to an order status, the classifying module 420 is configured for designating the high usage frequency phrases corresponding to an order status of incomplete as mid-sale quick phrases, and designating the high usage frequency phrases corresponding to an order status of complete as post-sale quick phrases.

In some further alternative embodiments, the server system 400 further includes a updating module configured for receiving from a client uploads of quick phrases sent. The update module is also configured for updating usage frequencies corresponding to the received quick phrases based upon results of the uploading, where the quick phrases are updated and optimized accordingly.

Embodiments of the present disclosure can be implemented using software, hardware, firmware, and/or the combinations thereof. Regardless of being implemented using software, hardware, firmware or the combinations thereof, instruction code can be stored in any kind of computer readable media (for example, permanent or modifiable, volatile or non-volatile, solid or non-solid, fixed or changeable medium, etc.). Similarly, such medium can be implemented using, for example, programmable array logic (PAL), random access memory (RAM), programmable read only memory (PROM), read only memory (ROM), electrically erasable programmable ROM (EEPROM), magnetic storage, optical storage, digital versatile disc (DVD), or the like.

It is necessary to point out that, modules or blocks described by embodiments of the present disclosures are logical modules or logical blocks. Physically, a logical module or logical block can be a physical module or a physical block, a part of a physical module or a physical block, or the combinations of more than one physical modules or physical blocks. Physical implementation of those logical module or logical blocks is not of essence. The realized functionalities realized by the modules, blocks and the combinations thereof are key to solving the problems addressed by the present disclosure. Further, in order to disclose the novelties of the present disclosure, the above described embodiments do not disclose about those modules or blocks not too related to solving the problems addressed by the present disclosure, which does not mean that the above described embodiments cannot include other modules or blocks.

It is also necessary to point out that, in the claims and specification of the present disclosure, terms such as first and second only are for distinguishing an embodiment or an operation from another embodiment or operation. It does not require or imply that those embodiments or operations having any such real relationship or order. Further, as used herein, the terms “comprising,” “including,” or any other variation intended to cover a non-exclusive inclusion, such that a process, method, article, or apparatus that comprises a list of elements does not include only those elements but may include other elements not expressly listed or inherent to such process, method, article, or apparatus. Absent further limitation, elements recited by the phrase “comprising a” does not exclude a process, method, article, or apparatus that comprises such elements from including other same elements.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable medium used to actually carry out the distribution. The embodiments disclosed herein may also be implemented using software modules that perform certain tasks. These software modules may include script, batch, or other executable files that may be stored on a computer-readable storage media or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present disclosure and its advantages have been described in detail, it should be understood that various changes substitutions, and alterations can be made herein without departing from the spirit and scope of the disclosure as defined by the appended claims. Many modifications and variations are possible in view of the above teachings. The embodiments were chosen and described in order to best explain the principles of the disclosure and its practical applications, to thereby enable others skilled in the art to best utilize the disclosure and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

What is claimed is:

1. A method of providing conversation quick phrases to a user of a conversation, the method comprising the steps of:
determining first identity information of the user and second identity information of another user who is a party to the conversation;
obtaining context information corresponding to the first identity information, the second identity information and the conversation;
determining a stage for the conversation based upon the identity information and the context information; and
providing the user with one or more conversation quick phrases corresponding to both the stage and the identity information, wherein:
a conversation quick phrase comprises words and information relating to instant messaging conversations of e-commerce transactions, and
the context information is selected from a group of order information corresponding to the identity information and item information corresponding to the conversation.

2. The method of claim 1, wherein the stage for the conversation is selected from the group of pre-sale, mid-sale and post-sale.

3. The method of claim 1, wherein:
the step of obtaining context information comprises the steps of:
querying to determine whether there is an order corresponding to the first identity information and the second identity information at the same time;
if there is an corresponding order, obtaining order status information based upon an order ID of the order, wherein the order ID and the order status information is designated as the order information, the order status information indicating a status of complete or incomplete; and
if there is no corresponding order, determining an item ID and category information of an item based upon information of the conversation, wherein the item ID and the category information is designated as the item information.

4. The method of claim 2, wherein the step of determining a stage for the conversation based upon the identity information and the context information comprises:
if the context information is order information and the order status information of the order information is incomplete, determining the stage for the conversation as mid-sale;
if the context information is order information and the order status information of the order information is complete, determining the stage for the conversation as post-sale; and
if the obtained information is item information, determining the stage for the conversation as pre-sale.

5. The method of claim 2, wherein the step of providing the user with one or more conversation quick phrases corresponding to both the stage and the identity information comprises:
retrieving from a server, if the first identity information of the user indicates a customer status and the stage for the conversation is mid-sale or post-sale, presently available conversation quick phrases corresponding to the customer status for mid-sale and post-sale stages, and returning to the user the conversation quick phrases corresponding to the stage for the conversation;
retrieving from a server, if the first identity information of the user indicates a vendor status, presently available conversation quick phrases corresponding to the vendor status for pre-sale, mid-sale and post-sale stages, and returning to the user the conversation quick phrases corresponding to the stage for the conversation; and
retrieving from a server, if the first identity information of the user indicates a customer status and the stage for the conversation is pre-sale, presently available conversation quick phrases corresponding to the customer status, and returning to the user the conversation quick phrases corresponding to the category information.

6. The method of claim 3, wherein the step of determining an item ID and category information of an item based upon information the conversation comprises the steps of:
obtaining link information from the information of the conversation;
determining whether the link information relates to an item;
in response to a determination that the link information relates to an item, obtaining an item ID of the item related to the link information and determining category information based upon the item ID.

7. The method of claim 2, further comprising the steps of, prior to the step of providing the user with one or more conversation quick phrases corresponding to both the stage and the identity information:
determining whether the category information includes specification information if the stage for the conversation is pre-sale; and
in response to a determination that the category information includes specification information, obtaining and displaying to the user a pre-determined format for configuring the specification information.

8. The method of claim 2, further comprising the steps of, prior to the step of providing the user with one or more conversation quick phrases corresponding to both the stage and the identity information:
determining whether the category information relates to clothing or footwear if the stage for the conversation is pre-sale; and
in response to a determination that the category information relates to clothing or footwear, obtaining and displaying to the user a pre-determined format for size configuration.

9. The method of claim 1, further comprising the steps of, after the step of providing the user with one or more conversation quick phrases corresponding to both the stage and the identity information:
obtaining conversation quick phrases selected by the user; and
sending the conversation quick phrases selected by the user to the other user of the conversation.

10. The method of claim 7, further comprising the steps of, after the step of providing the user with one or more conversation quick phrases corresponding to both the stage and the identity information:
obtaining configuration information input by the user with the pre-determined format; and
generating one or more configuration related quick phrases corresponding to the user based upon the configuration information, and sending the configuration related quick phrases to the other user of the conversation.

11. The method of claim 8, further comprising the steps of, after the step of providing the user with one or more conversation phrases corresponding to the stage and the identity information:
obtaining size information input by the user with the pre-determined format; and
generating one or more size related quick phrases corresponding to the user based upon the size information, and sending the size related quick phrases to the other user of the conversation.

12. The method of claim 1, further comprising the steps of, prior to the step of determining first identity information of the user and second identity information of an other user who is a party to the conversation:
receiving from the user a request for establishing the conversation and obtaining content from the request;
if the request contains an web page identification corresponding to an item, based upon the web page identification, generating link information related to the item and prompting the user about whether to send the link information; and
if the request contains an order identification corresponding to an order, continuing to determine the identity information of the user and the identity information of the other user.

13. A client system for providing conversation quick phrases to a user of a conversation, the client system comprising:
a processor; and
a non-transitory computer-readable medium operably coupled to the processor, the non-transitory computer-readable medium having computer-readable instructions stored thereon to be executed when accessed by the processor, the instructions comprising:
an identity determination module configure for determining first identity information of the user and second identity information of another user who is a party to the conversation;
an information obtaining module configured for obtaining context information corresponding to the identity information and the conversation;
a stage determination module configure for determining a stage for the conversation based upon the first identity information, second identity information and the context information; and
an information providing module configured for providing the user with one or more conversation quick phrases corresponding to both the stage and the identity information, wherein:
a conversation quick phrase comprises words and information relating to instant messaging conversations of e-commerce transactions, and
the context information is selected from a group of order information corresponding to the identity information and item information corresponding to the conversation.

14. The client system of claim 13, wherein:
the information obtaining module comprises:
an inquiry sub-module configured for querying to determine whether there is an order corresponding to the first identity information and the second identity information at the same time; and
an order information obtaining sub-module configured for, if there is an corresponding order, obtaining order status information based upon an order ID of the order, wherein the order ID and the order status information is designated as the order information, the order status information indicating a status of complete or incomplete.

15. The client system of claim 13, wherein the information providing module is configured for:
retrieving from a server, if the first identity information of the user indicates a customer status and the stage for the conversation is mid-sale or post-sale, presently available conversation quick phrases corresponding to the customer status for mid-sale and post-sale stages, and returning to the user the conversation quick phrases corresponding to the stage for the conversation;
retrieving from a server, if the first identity information of the user indicates a vendor status, presently available conversation quick phrases corresponding to the vendor status for pre-sale, mid-sale and post-sale stages, and returning to the user the conversation quick phrases corresponding to the stage for the conversation; and
retrieving from a server, if the first identity information of the user indicates a customer status and the stage for the conversation is pre-sale, presently available conversation quick phrases corresponding to the customer status, and returning to the user the conversation quick phrases corresponding to the category information.

16. A method for providing conversation quick phrases by a server, the method comprising the steps of:
retrieving from the server's data store presently stored conversation phrases;
filtering the retrieved conversation phrases to obtain high usage frequency phrases corresponding to category information and classifying the filtered high usage frequency phrases into quick phrases corresponding to stages of a conversation, wherein the category information comprises categories of items and statuses of orders; and
converting and arranging, according to a pre-determined format, the quick phrases such that a client periodically obtains the quick phrases from the server and updates accordingly, wherein a quick phrase comprises words and information relating to instant messaging conversations of e-commerce transactions.

17. The method of claim 16, wherein the step of filtering the retrieved conversation phrases to obtain high usage frequency phrases corresponding to category information and classifying the filtered high usage frequency phrases into quick phrases corresponding to stages of a conversation comprises the steps of:
designating the high usage frequency phrases corresponding to categories of items as pre-sale quick phrases and categorizing the quick phrases according to the categories, if the high usage frequency phrases correspond to the categories of items;
designating the high usage frequency phrases corresponding to an order status of incomplete as mid-sale quick phrases and designating the high usage frequency phrases corresponding to an order status of complete as post-sale quick phrases, if the high usage frequency phrases correspond to the statuses of orders.

18. The method of claim 16, further comprising the step of, after the steps of converting and arranging:
receiving from the client uploads of quick phrases sent; and
updating usage frequencies corresponding to the quick phrases based upon results of the uploads, wherein the quick phrases are updated and optimized accordingly.

19. A server system for providing conversation quick phrases to a user of a conversation, the server system comprising:
a processor; and
a non-transitory computer-readable medium operably coupled to the processor, the non-transitory computer-readable medium having computer-readable instructions stored thereon to be executed when accessed by the processor, the instructions comprising:
an obtaining module configured for retrieving from the server's data store presently stored conversation phrases;
a classifying module configured for filtering the retrieved conversation phrases to obtain high usage frequency phrases corresponding to category information and classifying the filtered high usage frequency phrases into quick phrases corresponding to stages of a conversation, wherein the category information comprises categories of items and statuses of orders; and
a processing module configured for converting and arranging, according to a pre-determined format, the quick phrases such that a client periodically obtains the quick phrases from the server and updates accordingly, wherein a quick phrase comprises words and information relating to instant messaging conversations of e-commerce transactions.

20. The server system of claim 19, wherein the stage of a conversation is selected from the group of pre-sale, mid-sale and post-sale.
